(19) United States
(12) Patent Application Publication
(10) Pub. No.: US 2012/0028063 A1
(43) Pub. Date: Feb. 2, 2012

(54) POLYBUTYLENE TEREPHTHALATE RESIN COMPOSITION FOR WELDING AND COMPOSITE MOLDED ARTICLE

(76) Inventor: Kouichi Sakata, Shizuoka, (JP)

(21) Appl. No.: 13/264,491

(22) PCT Filed: Apr. 12, 2010
(86) PCT No.: PCT/JP2010/056497

§ 371 Date: Oct. 14, 2011

(30) Foreign Application Priority Data
Apr. 20, 2009 (JP) 2009-101671

(51) Int. Cl. B32B 27/36; C08L 67/02; B29C 65/02

(52) U.S. Cl. 428/480; 156/308.2; 525/437; 525/64; 525/92 F; 524/605

(57) ABSTRACT

An object of the present invention is to provide a polybutylene terephthalate resin material which maintains high welding strength and has excellent durability in cold and heat cycle environment when joined each other by heat welding method. The polybutylene terephthalate resin composition for welding contains 100 parts by weight of (A) a polybutylene terephthalate resin having a terminal carboxyl group content of 30 meq/kg or less; (B) a carbodiimide compound in an amount such that the content of the carbodiimide functional group is 0.3 to 1.5 equivalent when the terminal carboxyl group content of the (A) polybutylene terephthalate resin is defined as 1; and 0 to 15 parts by weight of (C) an elastomer.

### TECHNICAL FIELD

The present invention relates to a polybutylene terephthalate resin composition for welding and to a composite molded article.

### BACKGROUND ART

Thermoplastic polyester resins representedbypolybutylene terephthalate (PBT) have excellent characteristics such as heat resistance, chemical resistance, electric characteristics, mechanical characteristics, and molding flowability, and thus they have been widely used in automobile fields, and electric and electronic fields, such as automobile electrical components (various control units, ignition coil components), motor components, varieties of sensor components, connector components, switch components, relay components, coil components, transformer components, lamp components, and the like. Through the use of these components, the polyester resin is used mainly as exterior materials for protecting electronic components, and thus these components are formed by several kinds of parts. To join these parts together, there have been applied screw fastening, adhesion, heat welding, and the like.

Screw fastening, however, raises problems of cost, time and efforts for tightening screw, and increased weight caused by insert-nut, screw, washer, or the like. In addition, an adhesive agent often causes loss of time until when it cures and requires fixing jig, which raises a problem of cost increase, and further raises a problem of the use of solvent from the viewpoint of environmental protection.

In contrast, the heat welding represented by laser welding, vibration welding, ultrasonic welding, hot plate welding, spin welding, and the like allows joining in a short time, and adhesive agents and metal components including screw are not used. Therefore, the heat welding does not raise problems of cost increase, weight increase, pollution, or the like, and thus the assembly work using the heat welding is increasing.

Furthermore, when the thermoplastic polyester resin is used as an exterior material for protecting electronic components, a metal terminal or the like for transmitting electric signals is often buried therein. However, for the components exposed to the environment of violent temperature rise/fall, such as automobile engine rooms, cracks are likely to be generated on the component by a strain caused by the difference of linear expansion between metal and resin, which results in deterioration of the functions of the component. Therefore, in order to prevent crack generation, the toughness is improved often by adding an elastomer and the like to the polybutylene terephthalate. Varieties of compositions have been proposed to improve the toughness.

For example, JP-A 3-285945 discloses the improvement of heat-shock resistance by adding an elastomer such as ethylene alkyl acrylate to the polybutylene terephthalate. However, although the provided resin mixture is recognized to exhibit an improvement compared with the additive-free resin, the heat-shock resistance is not satisfactory in some cases.

Furthermore, JP-A 60-210659 discloses the improvement of hot-water resistance by adding an elastomer such as ethylene alkyl acrylate and an epoxy resin or a carbodiimide to the polybutylene terephthalate. However, although the provided composition improves hot-water resistance, the composition does not give sufficient heat-shock resistance.

Moreover, JP-A 2004-315805 discloses the improvement of laser weldability and heat-shock resistance by using the polybutylene terephthalate and an elastomer having a specified refractive index. However, when large amounts of elastomer are applied for improving heat-shock resistance, vibration welding or the like raises problems of providing the cause of insufficient welding and decreasing the welding strength by coagulation of the elastomer.

As described above, the addition of an elastomer in order to improve toughness is a known practice. However, there has been no solution to the problem of decreasing the welding strength when an elastomer is added in an amount necessary to improve the toughness.

### DISCLOSURE OF THE INVENTION

The present invention has been made to solve the above conventional technical problems, and an object of the present invention is to provide a polybutylene terephthalate resin material maintaining high welding strength and having excellent durability in cold and heat cycle environment, when joining the molded articles of polybutylene terephthalate resin by heat welding method represented by laser welding, vibration welding, ultrasonic welding, hot plate welding, spin welding, and the like.

The inventors of the present invention have carried out detailed studies to obtain a polybutylene terephthalate resin composition capable of achieving the above object, and have found that a composition which is made mainly of a polybutylene terephthalate resin having a terminal carboxyl group content of 30 meq/kg or less, and which contains a combination of a specific amount of a carbodiimide compound and, as necessary, a certain amount or less of an elastomer, exhibits excellent heat-shock resistance and can maintain high welding strength, thus having perfected the present invention.

That is, the present invention relates to a polybutylene terephthalate resin composition for welding containing: 100 parts by weight of (A) a polybutylene terephthalate resin having a terminal carboxyl group content of 30 meq/kg or less; (B) a carbodiimide compound in an amount such that the content of the carbodiimide functional group is 0.3 to 1.5 equivalent when the terminal carboxyl group content of the (A) polybutylene terephthalate resin is defined as 1; and 0 to 15 parts by weight of (C) an elastomer; and

a composite molded article obtained by joining molded articles of the above polybutylene terephthalate resin composition together through heat welding, and a composite molded article obtained by joining a molded article of the polybutylene terephthalate resin composition with a molded article of other materials through heat welding.

According to the present invention, there is provided a polybutylene terephthalate resin composition for welding, having excellent performance such as high durability in cold and heat cycle environment and having excellent joining workability in heat welding. The polybutylene terephthalate resin composition for welding according to the present invention is useful in various composite molded articles, specifically in a molded article with metal or the like inserted.

### BRIEF DESCRIPTION OF THE DRAWINGS

FIG. 1(a) and FIG. 1(b) illustrate the test pieces used for the laser weldability testing and the test method thereof in Examples, respectively. It should be noted that the unit of the figures in FIG. 1 is millimeter.

FIG. 2 illustrates the test pieces used for the vibration weldability testing in Examples. It should be noted that the unit of the figures in FIG. 2 is millimeter.

### BEST MODES FOR CARRYING OUT THE INVENTION

The detailed description of the components constituting the resin material according to the present invention will be given as follows. The (A) polybutylene terephthalate resin as the base resin having the resin composition of the present invention is a polybutylene terephthalate resin obtained by polycondensation of a dicarboxylic component containing at least terephthalic acid or an ester-forming derivative thereof (such as lower alcohol ester) with a glycol component containing at least C4 alkylene glycol (1,4-butanediol) or an ester-forming derivative thereof. The polybutylene terephthalate resin is not specifically limited to homopolybutylene terephthalate resin, and may be a copolymer containing 60% by mole or more (specifically about 75% to 95% by mole) of butylene terephthalate unit.

According to the present invention, the polybutylene terephthalate resin to be used is obtained by dissolving a crushed sample of polybutylene terephthalate resin in benzyl alcohol at 215° C. for 10 minutes, which is then titrated by a 0.01N sodium hydroxide aqueous solution to thereby have a determined terminal carboxyl group content of 30 meq/kg or less, preferably 25 meq/kg or less.

The use of a polybutylene terephthalate resin in which the terminal carboxyl group content exceeds 30 meq/kg lowers the effect of improving the heat-shock resistance and increases the reduction of strength caused by hydrolysis in a hygrothermal environment.

Although the lower limit of the terminal carboxyl group content is not specifically limited, generally the resin having the terminal carboxyl group content of less than 5 meq/kg is difficult to be manufactured, and the resin having the terminal carboxyl group content of less than 5 meq/kg fails to sufficiently progress the reaction with the carbodiimide compound, which may result in an insufficient effect of improving the heat-shock resistance. Consequently, the terminal carboxyl group in the polybutylene terephthalate resin content is preferably 5 meq/kg or more, and is specifically, preferably 10 meq/kg or more.

Furthermore, the intrinsic viscosity (IV) of the (A) polybutylene terephthalate resin to be used is preferably in a range of 0.67 to 0.90 dL/g. If the IV exceeds 0.90 dL/g, the flowability during molding, necessary for insert-molded article may not be attained. As an example, the IV of 0.90 dL/g or less may be realized by blending polybutylene terephthalate resins having different IVs from each other, such as blending polybutylene terephthalate resins having an IV of 1.00 dL/g and 0.70 dL/g, respectively, with each other. It should be noted that the IV value can be determined, for example, in o-chlorophenol at the temperature of 35° C.

In the polybutylene terephthalate resin, the dicarboxylic acid component (comonomer component) other than terephthalic acid and an ester-forming derivative thereof includes: for example, aromatic dicarboxylic acid component (such as C6-C12 aryl dicarboxylic acid including isophthalic acid, phthalic acid, naphthalene dicarboxylic acid, and diphenylether dicarboxylic acid); aliphatic dicarboxylic acid component (such as C4-C16 alkyl dicarboxylic acid including succinic acid, adipic acid, azelaic acid, and sebacic acid, and C5-C10 cycloalkyl dicarboxylic acid including cyclohexane dicarboxylic acid); and an ester-forming derivative thereof. These dicarboxylic acid components can be used alone or in combination of two or more of them.

Preferred dicarboxylic acid component (comonomer component) includes aromatic dicarboxylic acid component (specifically C6-C10 aryl dicarboxylic acid such as isophthalic acid), and aliphatic dicarboxylic acid component (specifically C6-C12 alkyl dicarboxylic acid such as adipic acid, azelaic acid, and sebacic acid).

Examples of the glycol component (comonomer component) other than 1,4-butanediol include an aliphatic diol component [such as alkylene glycol (C2-C10 alkylene glycol such as ethylene glycol, propylene glycol, trimethylene glycol, 1,3-butylene glycol, hexamethylene glycol, neopentyl glycol, or 1,3-octane diol; and polyoxy C2-C4 alkylene glycol such as diethylene glycol, triethylene glycol, or dipropylene glycol); or alicyclic diol such as cyclohexane dimethanol or hydrogenated bisphenol A], an aromatic diol component [such as aromatic alcohol including bisphenol A or 4,4-dihydroxybiphenyl, and C2-C4 alkylene oxide adduct of bisphenol A (such as ethylene oxide 2-mole adduct of bisphenol A or propylene oxide 3-mole adduct of bisphenol A)], and an ester-forming derivative thereof. These glycol components can also be used alone or in combination of two or more of them.

Preferred glycol component (comonomer component) includes an aliphatic diol component (specifically C2-C6 alkylene glycol; polyoxy C2-C3 alkylene glycol such as diethylene glycol; and alicyclic diol such as cyclohexane dimethanol).

Any of the polybutylene terephthalate polymer obtained by polycondensation of the above compound as the monomer component can be used as the (A) component of the present invention. Combined use of a homopolybutylene terephthalate polymer with a copolymer of polybutylene terephthalate is also useful.

The (B) carbodiimide compound used in the present invention is a compound having a carbodiimide group (—N═C═N—) in the molecule. Applicable carbodiimide compound includes any of an aliphatic carbodiimide compound having an aliphatic main chain, an alicyclic carbodiimide compound having an alicyclic main chain, and an aromatic carbodiimide compound having an aromatic main chain, and a preferred one is an aromatic carbodiimide compound in viewpoint of hydrolysis resistance.

Examples of the aliphatic carbodiimide compound include diisopropyl carbodiimide and dioctyldecyl carbodiimide. The alicyclic carbodiimide compound includes dicyclohexyl carbodiimide or the like.

Examples of the aromatic carbodiimide compound include: mono- or di-carbodiimide compound such as diphenyl carbodiimide, di-2,6-dimethylphenyl carbodiimide, N-tolyl-N′-phenyl carbodiimide, di-p-nitrophenyl carbodiimide, di-p-aminophenyl carbodiimide, d-p-hydroxyphenyl carbodiimide, di-p-chlorophenyl carbodiimide, d-p-methoxyphenyl carbodiimide, di-3,4-dichlorophenyl carbodiimide, di-2,5-dichlorophenyl carbodiimide, di-o-chlorophenyl carbodiimide, p-phenylene-bis-di-o-tolyl carbodiimide, p-phenylene-bis-dicyclohexyl carbodiimide, p-phenylene-bis-di-p-chlorophenyl carbodiimide, or ethylene-bis-diphenyl carbodiimide; and polycarbodiimide compound such as poly(4,4′-diphenylmethane carbodiimide), poly(3,5′-dimethyl-4,4′-biphenylmethane carbodiimide), poly(p-phenylene carbodiimide), poly(m-phenylene carbodiimide), poly(3,5′-dimethyl-4,4′-diphenylmethane carbodiimide), poly(naphthylene carbodiimide), poly(1,3-diisopropylphenylene carbodiimide), poly(1-methyl-3,5-diisopropylphenylene carbodiimide), poly(1,3,5-triethylphenylene carbodiimide), or poly(triisopropylphenylene carbodiimide). These compounds can be used in combination of two or more of them. Among these compounds, specifically preferred ones to be used are di-2,6-dimethylphenyl carbodiimide, poly(4,4′-diphenylmethane carbodiimide), poly(phenylene carbodiimide), and poly(triisopropylphenylene carbodiimide).

Furthermore, the (B) carbodiimide compound has preferably a molecular weight of 2000 or more, and has more preferably a molecular weight of 10000 or more. The (B) carbodiimide compound having a molecular weight of less than 2000 may generate large amounts of gas or odor when the retention time is long at the time of melt kneading and molding process.

The blending amount of (B) carbodiimide compound corresponds to the amount such that the content of the carbodiimide functional group is 0.3 to 1.5 equivalents when the terminal carboxyl group content of the (A) polybutylene terephthalate resin is defined as 1.

If the amount of (B) component is excessively small, the effect of improving the heat-shock resistance, which is an object of the present invention, cannot be attained. Furthermore, if the amount of (B) component is excessively large, there likely appear the lowering of flowability and the generation of gel component and carbide at the time of compounding and molding processing, and there appear the deterioration of the mechanical characteristics such as tensile strength and flexural strength, and the rapid decrease in strength in hygrothermal environment. This is due to the inhibition of adhesion between the polybutylene terephthalate resin and the inorganic filler, caused by the (B) component. A preferable blending amount of the (B) component corresponds to the amount such that the content of the carbodiimide functional group is 0.5 to 1.5 equivalents, and is further preferably 0.8 to 1.2 equivalents.

The polybutylene terephthalate resin composition of the present invention can contain (C) an elastomer. A preferred elastomer is a thermoplastic elastomer and a core-shell elastomer. Applicable thermoplastic elastomer includes grafted olefin-based one, styrene-based one, and polyester-based one.

The addition amount of (C) elastomer is 15 parts by weight or less relative to 100 parts by weight of the (A) polybutylene terephthalate resin, preferably in a range of 1 to 10 parts by weight, and more preferably in a range of 5 to 10 parts by weight. If the amount of (C) elastomer is less than 1 part by weight, the effect of improving the heat-shock resistance becomes smaller, and if the amount thereof is more than 15 parts by weight, the weldability deteriorates.

Preferred grafted olefin-based elastomer includes a copolymer with the main component of ethylene and/or propylene. Preferable ones to be used include a graft copolymer structured by one or more of: olefin-based polymer of (a-1) ethylene-unsaturated carboxylic acid alkylester copolymer or (a-2) olefin-based copolymer of α-olefin and glycidyl ester of α,β-unsaturated acid; and (b) polymer or copolymer constituted mainly by repeating units represented by the general formula (1), one or more thereof being chemically bonded in branched or cross-linked structure.

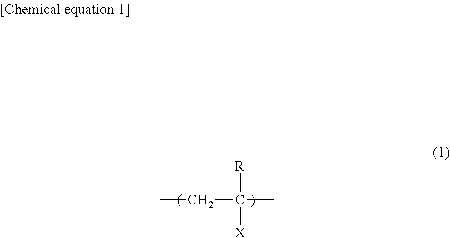

where, R signifies hydrogen or a lower alkyl group; X signifies one, two or more groups selected from —COOCH₃, —COOC₂H₅, —COOC₄H₉, —COOCH₂CH(C₂H₅)C₄H₉, —C₆H₅, and —CN.

That type of graft copolymer specifically improves heat-shock resistance.

Specific examples of the (a-1) ethylene-unsaturated carboxylic acid alkylester copolymer include random copolymers such as ethylene-acrylic acid copolymer, ethylene-methacrylic acid polymer, ethylene-acrylic acid-ethyl acrylate copolymer, ethylene-ethyl acrylate copolymer, ethylene-vinylacetate copolymer, and ethylene-vinylacetate-ethyl acrylate copolymer. Furthermore, these copolymers can be used by mixing them. Moreover, examples of the α-olefin that is a monomer constituting the (a-2) olefin-based copolymer include ethylene, propylene, and butene-1. Among these, ethylene is preferably used. In addition, the glycidyl ester of α,β-unsaturated acid that is another monomer constituting the (a-2) component is a compound represented by the general formula (2), and includes, for example, acrylic acid glycidyl ester, methacrylic acid glycidyl ester, ethacrylic acid glycidyl ester, and the like. Among these, methacrylic acid glycidyl ester is specifically, preferably used.

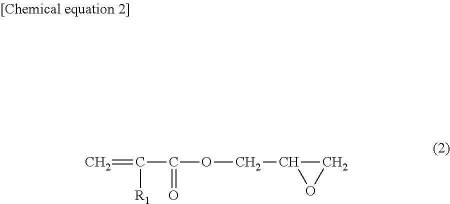

where, R₁ signifies hydrogen atom or lower alkyl group.

The olefin-based copolymer of α-olefin (such as ethylene) and glycidyl ester of α,β-unsaturated acid can be obtained by copolymerization through a generally known radical polymerization reaction. The ratio between the α-olefin and the glycidyl ester of α,β-unsaturated acid is preferably 70 to 99% by weight of the α-olefin, and 1 to 30% by weight of the glycidyl ester of α,β-unsaturated acid.

Next, the (b) polymer or copolymer which is graft-polymerized with the olefin-based copolymer (a-1) or (a-2) is a copolymer constituted by a sole polymer of a single kind of repeating unit represented by the general formula (1), or by two or more kinds thereof. Examples of the (b) polymer include polymethyl methacrylate, polyethyl acrylate, polybutyl acrylate, 2-ethylhexyl polyacrylate, polystyrene, polyacrylonitrile, acrylonitrile-styrene copolymer, butyl acrylate-methyl methacrylate copolymer, and butyl acrylate-styrene copolymer. Among these, specifically preferred one is butyl acrylate-methyl methacrylate copolymer. These polymers or copolymers (b) are also prepared by radical polymerization of the corresponding vinyl-based monomers.

The graft copolymer to be preferably used in the present invention does not make use of the (a-1) or (a-2) olefin-based copolymer or the (b) (co) polymer alone, and has features in that the graft copolymer has a branched or crosslinked structure in which the (a-1) or (a-2) copolymer and the (b) (co)polymer are chemically bonded at least at one position. Because of the graft structure, a remarkable effect which cannot be attained by the single composition of (a-1), (a-2) or (b) is obtained. Here, the ratio of (a-1) or (a-2) to (b) for constituting the graft copolymer is 95:5 to 5:95 (weight ratio), preferably 80:20 to 20:80.

Next, preferred styrene-based elastomer includes a block copolymer constituted by a polystyrene block and an elastomer block having a polyolefin structure. Examples of the styrene-based elastomer include styrene-isoprene-styrene block copolymer (SIS), styrene-ethylene.propylene-styrene block copolymer (SEPS), styrene-ethylene.butylene-styrene block copolymer (SEBS), and styrene-ethylene-ethylene/propylene-styrene block copolymer (SEEPS).

The polyester-based elastomer can be grouped into polyether type and polyester type. Any of them can be used if only their flexural modulus is 1000 MPa or less, preferably 700 MPa or less. If the bending elastic modulus exceeds 1000 MPa, sufficient flexibility cannot be attained. The polyether type corresponds to a polyester elastomer which has aromatic polyester as the hard segment, and has polyester of oxyalkyleneglycol polymer and dicarboxylic acid as the soft segment. The aromatic polyester unit in the hard segment is a polycondensate of dicarboxylic acid compound and hydroxyl compound, a polycondensate of oxycarboxylic acid compound, or a polycondensate of these three component compounds. For example, polybutylene terephthalate or the like is used as the hard segment. As the soft segment, there can be used a compound obtained by polycondensation of a polyalkylene glycol and a dicarboxylic acid. For example, there can be used an ester compound of polyoxytetramethylene glycol derived from tetrahydrofuran. The above polyether elastomer is commercially available as PERPRENE P-30B, P-70B, P-90B, P-280B manufactured by TOYOBO Co., LTD., Hytrel 4057, 4767, 6347, and 7247 manufactured by DuPont Toray Co., Ltd., LightFlex 655 manufactured by Ticona GmbH, and the like.

The polyester type corresponds to a polyester elastomer of an aromatic polyester as the hard segment and an amorphous polyester as the soft segment. The aromatic polyester unit in the hard segment is the same as that of the above polyether type. The soft segment is a ring-opening polymer of lactone, that is, polylactone or an aliphatic polyester derived from aliphatic dicarboxylic acid and aliphatic diol. The polyester type elastomer is commercially available as, for example, PREPRENE S-1002 and S-2002 manufactured by TOYOBO Co., LTD.

Next, the core-shell type elastomer is a polymer having multilayer structure constituted by the core layer (core part) and the shell layer covering apart of or entire core layer (surface of the core layer). The core-shell type elastomer has the core layer of rubber component (soft component), preferably acrylic rubber. The glass transition temperature of the rubber component may be, for example, less than 0° C. (for example, −10° C. or less), preferably −20° C. or less (for example, about −180° C. to −25° C.), and more preferably −30° C. or less (for example, about −150° C. to −40° C.).

The acrylic rubber as the rubber component is a polymer made mainly of acrylic monomer [specifically acrylic acid ester of alkylacrylate (acrylic acid C1-C12 alkylester such as butyl acrylate, preferably acrylic acid C1-C8 alkylester, more preferably acrylic acid C2-C6 alkylester) or the like]. The acrylic rubber may be a single polymer or a copolymer of acrylic monomer (such as copolymer of acrylic monomers, and copolymer of acrylic monomer with other unsaturated bond-containing monomer), and may be a copolymer of acrylic monomer (and other unsaturated bond-containing monomer) with a crosslinkable monomer.

The polybutylene terephthalate resin composition according to the present invention can further contain (D) an inorganic filler. The (D) inorganic filler is a fibrous filler or a non-fibrous filler. Among these, the fibrous filler is preferred. Since the single use of a plate-like or granular non-fibrous inorganic filler, such as glass bead, glass flake, silica, kaolin, talc, clay, wollastonite, titanium oxide, zinc oxide, alumina, calcium carbonate, or magnesium carbonate makes it difficult to be able to obtain sufficient strength, they are preferably used in combination with a fibrous filler.

The fibrous filler to be used in the present invention includes glass fiber, carbon fiber, potassium titanate fiber, silica-alumina fiber, zirconia fiber, metal fiber, and organic fiber. Among these, glass fiber is preferred.

Any of known glass fibers is preferably used as the glass fiber irrespective of fiber diameter, shape (cylinder, cocoon cross-section, ellipse cross-section, and the like), and length and glass cutting method when used for the production of chopped strand, roving, or the like. According to the present invention, the type of glass is not limited. From the viewpoint of quality, however, there are preferably used E-glass and anticorrosive glass containing zirconium element in the glass composition.

Furthermore, in the present invention, in order to improve the interface characteristics between a fibrous filler and a resin matrix, there is specifically, preferably used a fibrous filler which is surface-treated by an organic treatment agent such as an amino silane compound and an epoxy compound. A glass fiber having 1% by weight or larger amount of organic treatment agent, expressed by the ignition loss value, is specifically preferably used. As the amino silane compound and the epoxy compound preferably used in that kind of fibrous filler, any of known compounds can be used irrespective of the type of amino silane compound and epoxy compound used in the surface treatment of the fibrous filler according to the present invention.

The amount of the (D) inorganic filler is 10 to 100 parts by weight relative to 100 parts by weight of the (A) polybutylene terephthalate resin. If the amount of the (D) inorganic filler is less than the above range, the change in linear expansion accompanied with the cold and heat cycle becomes large, which is unfavorable from the viewpoint of heat-shock resistance. If the amount of the (D) inorganic filler exceeds the above range, the allowable strain value of the material decreases, which is unfavorable from the viewpoint of heat-shock resistance. A preferable range thereof is from 20 to 80 parts by weight, and a more preferable range is from 30 to 60 parts by weight.

In order to further provide desired characteristics depending on the use object, the composition of the present invention may further contain known materials being added to general thermoplastic resins and thermosetting resins, that is, stabilizer such as antioxidant, heat stabilizer, UV absorber; antistatic; coloring matter such as dye and pigment; lubricator; plasticizer and crystallization accelerator; crystal nucleating agent; epoxy compound, and the like.

The resin composition used in the present invention can be easily prepared by apparatus and method to be generally used in preparing conventional resin compositions. Examples of the method that can be used include: (1) mixing the respective components, and then kneading and extruding the mixture through a single or twin screw extruder to thereby prepare pellets, which are then molded; (2) preparing pellets having different compositions from each other, mixing these pellets in a specified amount to thereby be subjected to molding, and then obtaining the molded article having a desired composition; (3) directly supplying one or more of the respective components to a molding machine, and the like. Furthermore, the method in which a part of the resin components is crushed to fine powder, and the resultant powder is then mixed with other components to thereby be added, is preferable in performing a homogeneous mixture of components.

Moreover, the (B) carbodiimide compound can be added as the master batch with a resin in the form of matrix, and the use of the master batch often provides easy practical handling. A master batch of polybutylene terephthalate resin is appropriately used, but the master batch prepared through the use of other resins also be used. In the case of polybutylene terephthalate resin master batch, preparation may proceed so that the content thereof is within a specified range. The master batch may be added in advance at the time of melt kneading to thereby form homogeneous pellets. Alternatively, components other than a carbodiimide compound can be formed in advance to homogeneous pellets by melt kneading, and pellet blends in which the carbodiimide master batch pellets have been dry-blended with these pellets at the time of molding, may be used for molding.

The molded article of the polybutylene terephthalate resin composition according to the present invention can be joined each other by heat welding method represented by laser welding, vibration welding, ultrasonic welding, hot plate welding, spin welding, and the like, maintains high welding strength, and exhibits excellent durability in cold and heat cycle environments. Therefore, the molded articles can be used in wide fields including automobile fields, electric and electronic fields, and the like.

According to the present invention, the (A) molded article of the above polybutylene terephthalate resin composition and (B) other molded article can be joined together by heat welding described above to obtain a composite molded article. In this case, the (B) other molded article can have the same material as that of the (A) molded article of the above polybutylene terephthalate resin composition, or can have a different material therefrom.

When the molded article of the polybutylene terephthalate resin composition is an insert-molded article, the effect of the present invention becomes significant.

As the heat welding method such as laser welding, vibration welding, ultrasonic welding, hot plate welding, or spin welding, conventionally known methods can be applied as they are. In the case of laser welding, the molded article of the above polybutylene terephthalate resin composition can be used at transmission side or absorption side, or naturally at both sides.

When the (A) molded article and the (B) other molded article are joined together by heat welding, there can be inserted functional parts such as packing, water-proof moisture-permeable sheet, film, and plastic lens between the joining surfaces of the (A) molded article and the (B) other molded article within a range not deteriorating the effect of the present invention.

### EXAMPLES

The present invention will be described in further detail below referring to Examples. The present invention, however, is not limited to these examples.

### Examples 1 to 7, Comparative Examples 1 to 6

The components shown in Table 1 were weighed respectively and dry-blended together, the blend was then melt-kneaded in a 30 mm dia. twin screw extruder (TEX-30, manufactured by The Japan Steelworks, Ltd.) to obtain pellets (at a cylinder temperature of 260° C., an extrusion rate of 15 kg/h, and a screw rotational speed of 150 rpm). Then, test pieces were formed from the pellets to determine the various physical properties. The result is given in Table 1.

The detail of used components and the method of evaluation of physical properties are as follows.

### (A) Polybutylene Terephthalate Resin

(A-1) Polybutylene terephthalate resin: manufactured by WinTech Polymer Ltd.; the intrinsic viscosity of 0.69, a terminal carboxyl group content of 24 meq/kg.

(A-2) Dimethyl isophthalic acid (DMI) modified polybutylene terephthalate resin: prepared by the reaction of terephthalic acid and 1,4-butanediol through the use of DMI 12.5% by mole as the copolymerizing component instead of a part of terephthalic acid (12.5% by mole); an intrinsic viscosity of 0.76, a terminal carboxyl group content of 25 meq/kg.

(A-3) Polybutylene terephthalate resin: manufactured by WinTech Polymer Ltd.; an intrinsic viscosity of 0.70, a terminal carboxyl group content of 45 meq/kg.

### (B) Carbodiimide Compound

(B-1) Aromatic carbodiimide compound: manufactured by Rhein Chemie Japan Co., Ltd.; STABACK SOL P, a molecular weight of 3000.

(B-2) Aromatic carbodiimide compound: manufactured by Rhein Chemie Japan Co., Ltd.; STABAC SOL P400, a molecular weight of 20000.

### (C) Elastomer

(C-1) MODIPER A5300 (ethylene ethylacrylate-graft-butylacrylate/methylmethacrylate), manufactured by NOF Corporation.

(C-2) SEPTON 4055 (polystyrene-poly(ethylene-ethylene/propylene) block polystyrene copolymer: manufactured by Kuraray Co., Ltd.

### (D) Glass Fiber

(D-1) ECS03-T127: manufactured by Nippon Electric Glass Co., Ltd.

### [Laser Weldability]

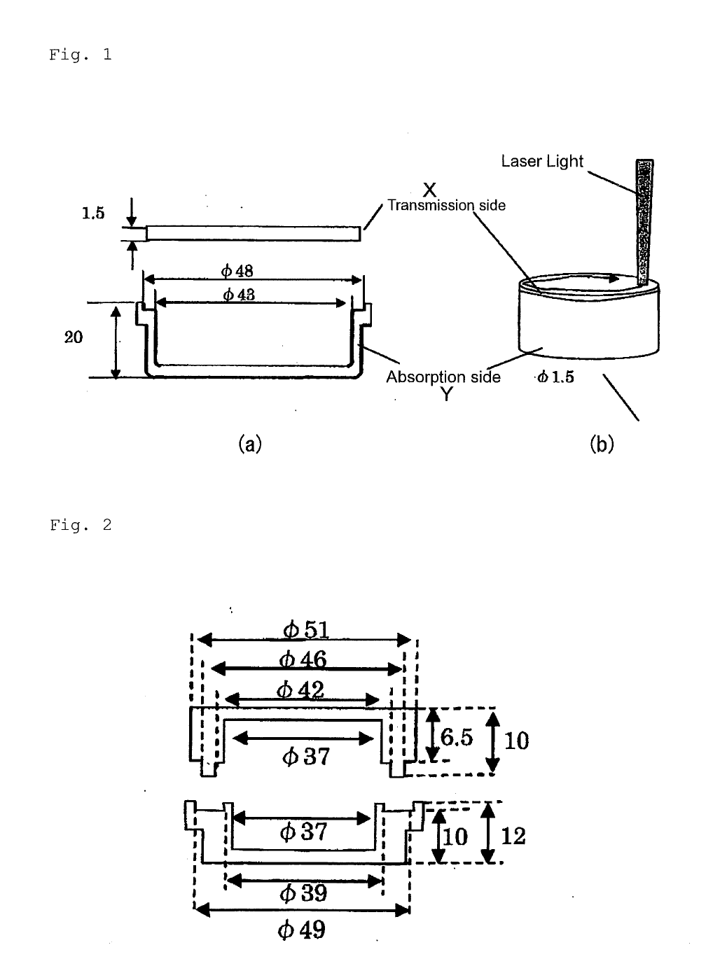

The test pieces in a circular disk shape, each illustrated in FIG. 1(a), with a thickness of 1.5 mm were irradiated with a laser light having a wavelength of 940 nm, an irradiation diameter of 1.5 mm, and an output power of 30 W to thereby join them together. Then, the fracture strength was determined.

After cutting the bottom surface, the punching fracture strength was determined through the use of a universal tester UTA-50KN manufactured by Orientec Co., Ltd. with a jig having a diameter of 42.2 mm, and at a test speed of 5 mm/min.

The test piece applied was a circular disk test piece having a thickness of 1.5 mm (X: transmission side) obtained by molding the above pellets, while the test pieces at absorption side (Y) were obtained by molding the above pellets containing 3% by weight of carbon black (trade name 2020B, manufactured by WinTech Polymer Ltd.) for black coloring. The absorption side test piece (Y) functions as heat-generating material under laser light.

### [Vibration Weldability]

Two kinds of cylindrical test pieces each illustrated in FIG. 2 were welded together through the use of ORBITAL WELDER MODEL-100 manufactured by BRANSON JAPAN COMPANY under conditions of an oscillation amplitude of 0.8 mm, a compressive force of 3 bar, and welding amount of 0.9 mm, and the fracture strength was determined.

After cutting the bottom surface, the punching fracture strength was determined under a universal tester UTA-50KN manufactured by Orientec Co., Ltd. through the use of a jig having a diameter of 36.6 mm and at a test speed of 5 mm/min.

Any of the above cylindrical test pieces was molded from the above pellets.

### [Heat-Shock Resistance]

Pellets were insert-injection molded in a test piece molding die (a die for inserting a steel core of 18 mm long, 18 mm wide, and 30 mm high inside a square pillar of 22 mm long, 22 mm wide, and 51 mm high) under conditions of a resin temperature of 260° C., a die temperature of 65° C., an injection time of 25 seconds, and a cooling time of 10 seconds so that the minimum thickness at a part of resin portion becomes 1 mm, and thus an insert-molded article was manufactured. Through the use of a cold and heat shock tester, the insert-molded article thus obtained was heated to 140° C. for one and a half hour, followed by being cooled to −40° C., maintained at the temperature for one and a half hour, and then further heated to 140° C. to thereby complete one cycle of the heat-shock resistance testing. The number of cycles until the molded article generated crack was determined to evaluate the heat-shock resistance.

TABLE 1

| | | Examples | | | | | | |
|---|---|---|---|---|---|---|---|---|
| | | 1 | 2 | 3 | 4 | 5 | 6 | 7 |
| (A) | A-1 (parts by weight) | 100 | 100 | 100 | 100 | 100 | | 100 |
| | A-2 (parts by weight) | | | | | | 100 | |
| | A-3 (parts by weight) | | | | | | | |
| (B) | B-1 (parts by weight) | 1.0 | 0.7 | | 0.8 | 0.8 | 0.8 | |
| | B-2 (parts by weight) | | | 0.7 | | | | 0.8 |
| (C) | C-1 (parts by weight) | | | | 7.8 | | 7.8 | |
| | C-2 (parts by weight) | | | | | 7.8 | | 12 |
| (D) | D-1 (parts by weight) | | 43.2 | 43.2 | 49.6 | 49.6 | 49.6 | 48.0 |
| Carbodiimide equivalent/Carboxyl group | | 1.3 | 1.0 | 1.0 | 1.0 | 1.0 | 1.0 | 1.0 |
| content | | | | | | | | |
| Evaluation | Laser welding strength (N) | 2000 | 5500 | 5500 | 1000 | 4000 | 1300 | 3800 |
| | Vibration welding strength (N) | — | 2700 | 2700 | 2200 | 2300 | 2300 | 2200 |
| | Heat-shock resistance | 100 | 300 | 300 | 1000< | 1000< | 1000< | 1000< |

| | | Comparative Examples | | | | | |
|---|---|---|---|---|---|---|---|
| | | 1 | 2 | 3 | 4 | 5 | 6 |
| (A) | A-1 (parts by weight) | 100 | 100 | 100 | 100 | 100 | |
| | A-2 (parts by weight) | | | | | | |
| | A-3 (parts by weight) | | | | | | 100 |
| (B) | B-1 (parts by weight) | | | | | 0.8 | 1.8 |
| | B-2 (parts by weight) | | | | | | |
| (C) | C-1 (parts by weight) | | | 7.7 | 16.8 | 16.8 | |
| | C-2 (parts by weight) | | | | | | |
| (D) | D-1 (parts by weight) | | 42.9 | 46.2 | 50.4 | 50.4 | |
| Carbodiimide equivalent/Carboxyl group | | — | — | — | — | 1.1 | 1.3 |
| content | | | | | | | |
| Evaluation | Laser welding strength (N) | 2000 | 5500 | 1000 | * | * | 2000 |
| | Vibration welding strength (N) | — | 2700 | 2200 | 1700 | 1700 | — |
| | Heat-shock resistance | 20 | 100 | 200 | 300 | 1000< | 70 |

* Laser transmission was insufficient, and thus the resin was not

1. A polybutylene terephthalate resin composition for welding, comprising:
100 parts by weight of (A) a polybutylene terephthalate resin having a terminal carboxyl group content of 30 meq/kg or less;
(B) a carbodiimide compound in an amount such that the content of the carbodiimide functional group is 0.3 to 1.5 equivalent when the terminal carboxyl group content of the (A) polybutylene terephthalate resin is defined as 1; and
0 to 15 parts by weight of (C) an elastomer.

2. The polybutylene terephthalate resin composition for welding of claim 1, further comprising 10 to 100 parts by weight of (D) an inorganic filler relative to 100 parts by weight of the (A) polybutylene terephthalate resin.

3. The polybutylene terephthalate resin composition for welding of claim 1, wherein the molecular weight of the (B) carbodiimide compound is 2000 or more.

4. A composite molded article, obtained by joining molded articles of the polybutylene terephthalate resin composition of claim 1 together by heat welding.

5. A composite molded article, obtained by joining a molded article of the polybutylene terephthalate resin composition of claim 1 with a molded article of another material by heat welding.

6. The composite molded article of claim 4, wherein the molded article of the polybutylene terephthalate resin composition is an insert-molded article.

7. The polybutylene terephthalate resin composition for welding of claim 2, wherein the molecular weight of the (B) carbodiimide compound is 2000 or more.

8. A composite molded article, obtained by joining molded articles of the polybutylene terephthalate resin composition of claim 2 together by heat welding.

9. A composite molded article, obtained by joining molded articles of the polybutylene terephthalate resin composition of claim 3 together by heat welding.

10. A composite molded article, obtained by joining molded articles of the polybutylene terephthalate resin composition of claim 7 together by heat welding.

11. A composite molded article, obtained by joining a molded article of the polybutylene terephthalate resin composition of claim 2 with a molded article of another material by heat welding.

12. A composite molded article, obtained by joining a molded article of the polybutylene terephthalate resin composition of claim 3 with a molded article of another material by heat welding.

13. A composite molded article, obtained by joining a molded article of the polybutylene terephthalate resin composition of claim 7 with a molded article of another material by heat welding.

14. A composite molded article, obtained by joining a molded article of the polybutylene terephthalate resin composition of claim 8 with a molded article of another material by heat welding.

15. A composite molded article, obtained by joining a molded article of the polybutylene terephthalate resin composition of claim 9 with a molded article of another material by heat welding.

16. A composite molded article, obtained by joining a molded article of the polybutylene terephthalate resin composition of claim 10 with a molded article of another material by heat welding.

17. The composite molded article of claim 5, wherein the molded article of the polybutylene terephthalate resin composition is an insert-molded article.

18. The composite molded article of claim 11, wherein the molded article of the polybutylene terephthalate resin composition is an insert-molded article.

19. The composite molded article of claim 12, wherein the molded article of the polybutylene terephthalate resin composition is an insert-molded article.

20. The composite molded article of claim 13, wherein the molded article of the polybutylene terephthalate resin composition is an insert-molded article.
